(19) United States
(12) Patent Application Publication
(10) Pub. No.: US 2009/0159585 A1
(43) Pub. Date: Jun. 25, 2009

(54) Cooking Appliance which is Mounted in an Elevated Manner

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch Und Siemens Hausgeraete GmbH, München (DE)

(21) Appl. No.: 11/992,221

(22) PCT Filed: Sep. 18, 2006
(86) PCT No.: PCT/EP2006/066433

§ 371 Date: Mar. 18, 2008

(30) Foreign Application Priority Data
Sep. 19, 2005 (DE) 10 2005 044 702.3

(51) Int. Cl. F27B 5/14

(52) U.S. Cl. 219/390

(57) ABSTRACT

A cooking appliance which is mounted in an elevated manner, comprising at least one muffle which defines a cooking chamber and which comprises a muffle opening on the base side thereof, a base door, which can be displaced, for closing the muffle opening and which comprises at least one heating field on the upper side thereof, having at least one operational state for the open state of the base door and at least one operational state for the closed state of base door. Only one operational state, which is relevant for the opening state of the base door, can be activated, and only one operational state for the open state when the base door is open and only one operational state for the closed state when the base door is closed.

The invention relates to a cooking appliance which is mounted in an elevated manner comprising at least one muffle which defines a cooking chamber and which comprises a muffle opening on the base side thereof, a base door which can be displaced, for closing the muffle opening and which comprises at least one heating field on the upper side thereof, having at least one operational state for the open state of the base door and at least one operational state for the closed state of the base door. The invention further relates to an associated operating method.

DE 100 59 652 A1 discloses for example such a cooking appliance which is mounted in an elevated manner, in which the heating field of the base door can be switched between a hob function and a bottom heat function and oven functionalities are available with a closed base door.

With the known constructions, it is disadvantageous that the different functionalities can be chosen freely. A user can thereby accidentally choose an operational state which is unsuitable for the current operating state of the cooking appliance which is mounted in an elevated manner and is possibly also unsafe, for example a functionality with activation of the upper heat with the base door or the cooking chamber in an open state.

It is the object of the present invention to provide a possibility for the safe and effective handling of the cooking appliance.

The present object is solved by the cooking appliance which is mounted in an elevated manner as claimed in claim 1 and a method as claimed in claim 7. Advantageous embodiments can be inferred from the dependent claims individually or in combination.

With the generic cooking appliance which is mounted in an elevated manner, only one operational state relevant for the open state of the base door can be activated, that is, only one operational state for the open state with an open base door, and only one operational state for the closed state with a closed base door. An open base door thereby corresponds to an open cooking chamber and a closed base door to a closed cooking chamber. By this restriction of the choice of operational states which can be activated, unsuitable and possibly unsafe operational states are excluded for the opening state (open/closed). Operator convenience is also increased.

It can be advantageous if a relevant operational state can be activated by actuating a confirmation button, and correspondingly actuation of a confirmation button for a non-relevant operational state initiates no activation of the non-relevant operational state. The design of the confirmation button (single button, multi-function button, toggle, foil button etc.) is left to the person skilled in the art.

An operational state for the open state can comprise a warming, hot plate or extended cooking function. An operational state for the closed state can comprise a warming, cooking, rapid heating-up or pyrolysis function.

It is particularly advantageous, if only one operational state which is relevant to the opening state of the base door or the cooking chamber is displayed. The user is for example only shown these operational states when switching through the operational states by means of an operational state selection switch.

Alternatively, a control panel can show the user an operational state which is relevant for the opening state of the base door as active, e. g. with normal brightness, and an operational state which is not relevant for the opening state as inactive, e. g by reduced brightness. Separate displays for the activatability of the operational state can also be provided.

The cooking appliance which is mounted in an elevated manner is described in detail with reference to the appended figures, in which;

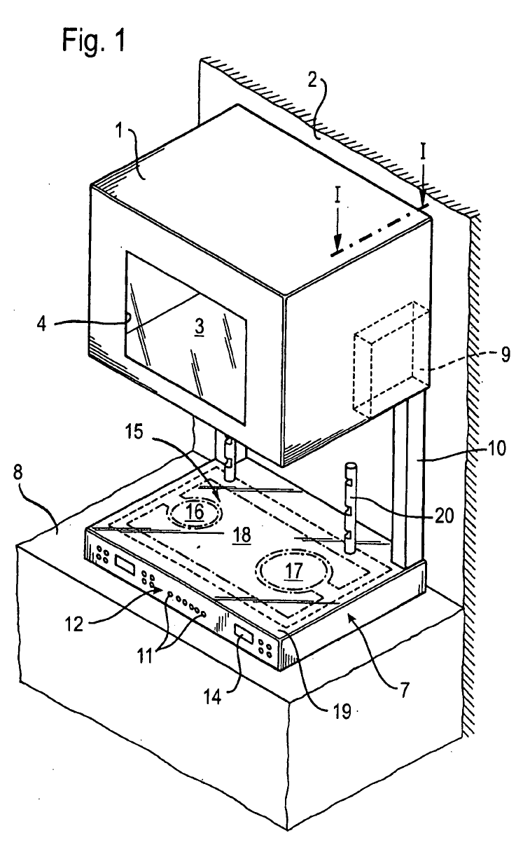

FIG. 1 shows a schematic representation of a perspective view of a cooking appliance which is mounted in an elevated manner with a lowered base door mounted to a wall;

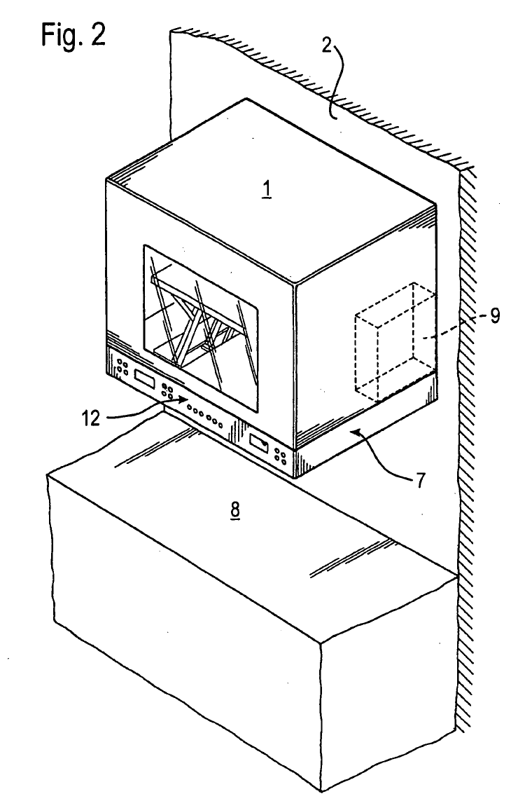

FIG. 2 shows a schematic representation of a perspective view of the cooking appliance which is mounted in an elevated manner with a closed base door;

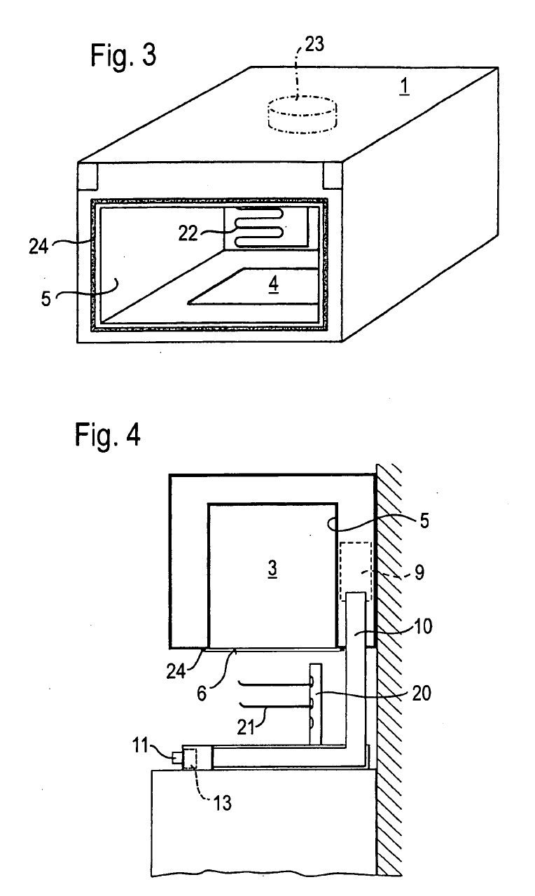

FIG. 3 shows a schematic representation of a perspective view of a housing of the cooking appliance which is mounted in an elevated manner without the base door;

FIG. 4 shows a schematic representation of a side view in section along line I-I from FIG. 1 of the cooking appliance which is mounted in an elevated manner with lowered base door mounted to the wall;

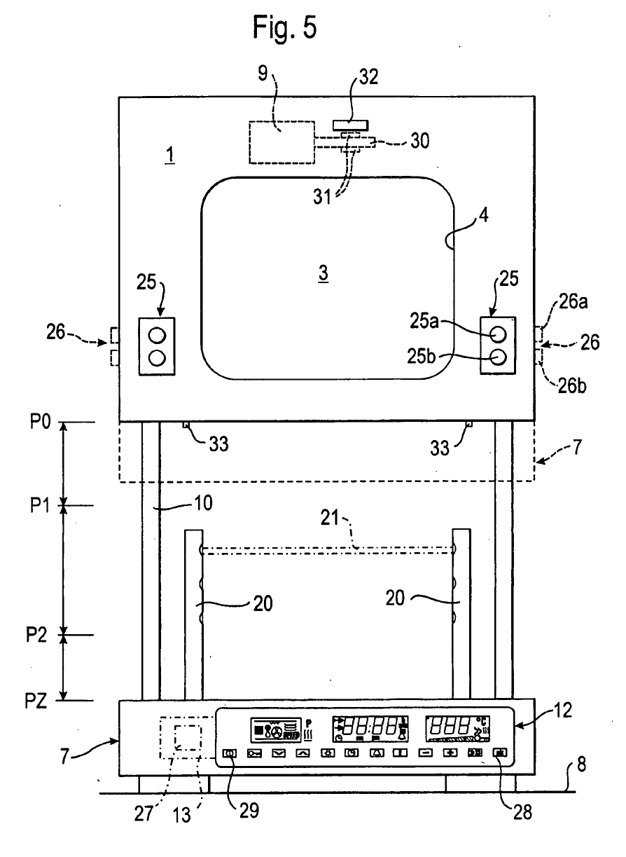

FIG. 5 shows a schematic representation of a further embodiment of a cooking appliance which is mounted in an elevated manner in a front view;

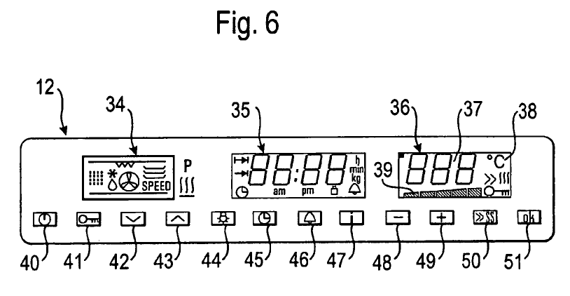

FIG. 6 shows a schematic representation of a view of a control panel of a cooking appliance which is mounted in an elevated manner.

The figures are not shown to scale for a better depiction of the individual elements.

FIG. 1 shows a cooking appliance which is mounted in an elevated manner with a housing 1. The rear of the housing 1 is mounted to a wall 2 in the manner of a suspended cabinet. A cooking chamber 3 is defined in the housing 1, which can be controlled by a viewing window 4 placed on the front side in the housing 1. In FIG. 4 it can be seen that the cooking chamber 3 is delimited by a muffle 5 which is provided with a heat-insulating casing (not shown), and that the muffle 5 comprises a muffle opening 6 on the base side. The muffle opening 6 can be closed with a base door 7. In FIG. 1, the base door 7 is shown in a lowered manner, wherein it is attached to a worktop 8 of a kitchen device with its lower side. The base door 7 has to be moved into the position shown in FIG. 2 so as to close the cooking chamber 3, the so-called “zero position”. The cooking appliance which is mounted in an elevated manner comprises a drive device 9, 10 for moving the base door 7. The drive device 9, 10 has a drive motor 9 shown in FIGS. 1, 2 and 4 with dashed lines, which is arranged between the muffle 5 and an outer wall of the housing 1. The drive motor 9 is arranged in the area of the rear of the housing 1 and is, as shown in FIG. 1 or 4, actively connected to a pair of lifting elements 10 which are connected to the base door 7. Thereby, every lifting element 10 is designed as an L-shaped carrier according to the schematic side view from FIG. 4, the vertical leg of which extends starting from the drive motor 9 on the housing side. For moving the base door 7, the drive motor 9 can be actuated with the help of a control panel 12 and a control circuit 13, which is arranged on the front side at the base door 7 according to FIGS. 1 and 2. As shown in FIG. 4, the control circuit 13 is behind the control panel 12 within the base door 7. The control circuit 13, which is composed here of several printed circuit boards separated spatially and functionally and communicating via a communication bus, constitutes a central control unit for the operation of the appliance and controls and/or regulates e. g. the heating, a base door 3 method, conversion of user inputs, lighting, protection against jamming, synchronizing of the heating elements 16, 17, 18, 22 and much more.

FIG. 1 shows that a top side of the base door 7 comprises a hob 15. Nearly the entire surface of the hob 15 is taken up by heating elements 16, 17, 18, which are indicated in FIG. 1 by a dot and dash line. In FIG. 1, the heating elements 16, 17 are two hot plate heating elements of different size which are distanced from one another, while the heating element 18 is a surface heating element provided between the two hot plate elements 16, 17, which almost encloses the hot plate heating elements 16, 17. The hot plate heating elements 16, 17 define associated cooking zones or hobs for the user; the hot plate heating elements 16, 17 together with the surface heating element 18 define a bottom heating zone. The zones can be indicated on the surface by a suitable decor. The heating elements 16, 17, 18 can respectively be controlled via the control circuit 13.

In the exemplary embodiment shown, the heating elements 16, 17, 18 are designed as radiation heating elements which are covered by a glass ceramic plate 19. The glass ceramic plate 19 has approximately the dimensions of the top side of the base door 7. The glass ceramic plate 19 is further equipped with mounting openings (not shown), through which the base projects in order to hold retaining parts 20 for food carriers 21, as also shown in FIG. 4. Instead of a glass ceramic plate 19, other covers—preferably rapidly-responding—can also be used, e. g. a thin metal sheet.

With the help of an operating toggle provided in the control panel 12, the cooking appliance which is mounted in an elevated manner can be switched to a hot plate or a bottom heating operational state, which are explained below.

The hot plate heating elements 16, 17 can be accessed individually via the control circuit 13 in the hot plate operational state by means of control elements 11 which are provided in the control panel 12, while the surface heating element 18 remains out of operation. The hot plate operational state can be carried out with a lowered base door 7, as shown in FIG. 1. But it can also be operated with a closed cooking chamber 3 with a raised base door 7 in an energy saving function.

In the bottom heating operational state, not only the hot plate heating elements 16, 17, but also the surface heating element 18, are controlled by the control device 13.

So as to achieve a browning surface of the food which is as even as possible during the bottom heating operation, it is essential that the hob 15 providing the bottom heat comprises an even distribution of the heat output over the surface of the hob 15, even though the heating elements 16, 17, 18 have different effective power. The heating elements 16, 17, 18 are therefore preferably not switched to a continuous operation by the control circuit 13, but the power supply to the heating elements 16, 17, 18 is clocked. The effective powers of the heating elements 16, 17, 18 of different sizes are thereby reduced individually in such a manner that the heating elements 16, 17, 18 create an even distribution of the heat output over the surface of the hob 15.

FIG. 3 schematically shows the position of a circulating air fan 23 with a circulating air motor and an associated ring heating element, e. g. for producing hot circulating air during a hot air operation. The circulating air fan 23 which is open towards the cooking chamber 3 is typically separated from this by a reflector plate (not shown). Furthermore, an upper heat heating element 22 mounted at the top side of the muffle 5 is provided which can be designed with one ring or several rings, e. g. with an inner and an outer ring. The different operational states, as for example also the upper heat, hot air or fast heating operation can be adjusted by the control circuit 13 by a corresponding switching on and adjustment of the heating power of the heating elements 16, 17, 18, 22, possibly with activation of the hot air fan 23. The adjustment of the heating power can take place by a suitable timing device. The hob 15 can also be designed differently, e. g. with or without an extended cooking zone, purely as a—with one or several rings—warming zone without hobs and so on. The housing 1 comprises a seal 24 towards the base door 7.

The control panel 12 is essentially arranged on the front side of the base door 7. Alternatively, other arrangements are also feasible, e.g. on the front side of the housing 1, divided on different partial fields and/or partially on side surfaces of the cooking appliance. Further configurations are possible. The control elements 11 are not limited in their construction and can e.g. comprise operating toggles, rocker switches, push buttons and foil buttons, the display elements 14 comprise e. g. LED, LCD and/or touch screen displays.

In FIG. 5, a cooking appliance which is mounted in an elevated manner is shown schematically and not to scale from the front, in which the base door 7 is open and attached to the worktop 8. The closed state is shown in with a dashed line.

In this embodiment, two movement control panels 25 are present at the front side of the housing 1 mounted in a fixed manner. Every movement control panel 25 comprises two push buttons, namely an upper CLOSE push button 25a for a base door 7 moving upwards in a closing direction and a lower OPEN push button 25b for a base door 7 moving downwards in an opening direction. Without automatic operation (see below), the base door 7 only moves upwards by continuous simultaneous pushing of the CLOSE buttons 25a of both movement control panels 25, if possible; the base door 7 also only moves downwards by continuously simultaneously pushing the OPEN buttons 25b of both movement control panels 25, if possible (manual operation). As an increased operating attention of the user is given with the manual operation, and furthermore both hands are used here, a protection against jamming is then only optional. With an alternative embodiment, movement control panels 26 are mounted at facing outer sides of the housing 1 with corresponding CLOSE buttons 26a and OPEN buttons 26B, as shown with dots.

With an activated operational state for the open state, a moving block implemented in the control circuit 13 prevents the open base door 7 from moving; however, not with an activated operational state for the closed state.

The control circuit 13 shown in a dot and dash line which is in the inside of the base door 7 behind the control panel 12, switches the drive motor 9 in such a manner that the base door 7 starts gently, that is, not abruptly by simply starting the drive motor 9, but by means of a defined ramp.

In this exemplary embodiment, the control circuit 13 comprises a memory unit 27 for storing at least a destination or movement position P0, P1, P2, PZ of the base door 7, preferably with volatile memory components, e. g. DRAMs. When a destination position P0, P1, P2, PZ is stored, the base door can move independently after actuating one of the buttons 25a, 25b or 26a, 26b of the movement control panels 25 or 26 into the adjusted direction, until the next destination position is reached or one of the buttons 25a, 25b or 26a, 26b is actuated again (automatic operation). In this exemplary embodiment, the lowermost destination position PZ corresponds to the maximum opening, the (zero) position P0 to the closed state, and P1 and P2 are freely adjustable intermediate positions. If the last destination position for a direction is reached, it has to be moved further with manual operation, if this is possible (that is, the last end positions do not correspond to a maximum open or the closed end state). In an analogous manner, when no destination position is stored for a direction—which would be e.g. the case for an upward movement into the closed position, if only PZ is stored, but not P0, P1, P2—one has to move in this direction with manual operation. If no destination position is stored, e.g. with a new installation or after a power cut, an automatic operation is not possible. If the base door 7 is moved in an automatic operation, a protection against jamming is preferably activated.

Automatic operation and manual operation do not exclude each other: by continual actuation of the movement control panels 25, 26, the base door 7 then also moves in the manual operation, if a destination position could be started in this direction. Thereby, a maximum actuation time of the movement panels 25 or 26, respective to the associated buttons 25a, 25b or 26a, 26b can be established for activating the automatic operation, e. g. 0.4 seconds.

A destination position P0, P1, P2, PZ can be an arbitrary position of the base door 7 between and including the zero position P0 and the maximum opening position PZ. The maximum stored opening position PZ does however not have to be the position attached to the worktop 8. A storing of the destination position P0, P1, P2 PZ can be carried out with the base door 7 in the desired destination position P0, P1, P2, PZ by means of, for example, actuating a confirmation button 28 in the control panel 12 for several seconds (e.g. lasting for two seconds). Optical and/or acoustic signal generators at hand, which emit corresponding signals after storing a destination position, are not shown for better clarity. Starting the desired destination position P0, P1, P2, PZ to be adjusted takes place for example by—in the exemplary embodiment—operation of the movement control panels 25 or 26 with both hands and manual movement to this position.

Only one, or as shown in this exemplary embodiment, also several destination positions P0, P1, P2, PZ can be stored in the memory unit 27. With several destination positions, P0, P1, P2, PZ they can be accessed successively by actuating the corresponding movement buttons 25a, 25b or 26a, 26b. The cooking appliance which is mounted in an elevated manner can easily be adjusted to the desired operating height of several users by several destination positions P0, P1, P2, PZ. The destination position(s) can advantageously be deleted and/or overwritten. In one embodiment, only one destination position can for example be stored in the open state, while the zero position P0 is recognized automatically and can be accessed automatically. Alternatively, the zero position P0 also has to be stored to be automatically accessible.

However, it is particularly advantageous for an ergonomic use, if the or a destination position P1, P2, PZ opens the base door 7 at least about 400 mm to about 540 mm (that is P1-P0, P2-P0, PZ-P0≧40 cm to 54 cm). With this extent of opening, the cooked food carriers 21 can simply be inserted into the retaining parts 20. It is thereby advantageous if the viewing window 4 is mounted at approximately the eye height of the user or a bit below this, e. g. by means of a gauge which indicates the measurements of the cooking appliance.

A power cut bypass for bypassing about 1 to 3 s of a power cut, preferably up to 1.5 s of a power cut, is not shown.

The drive motor 9 from FIG. 1 has arranged at least one sensor unit 31, 32 at a motor shaft 30, possibly in front of or behind a gear to measure a movement path or a position and/or a speed of the base door 7. The sensor unit can for example comprise one or more induction, Hall, optical, OFW sensors etc. Thereby, two Hall (part) elements 31 are mounted here offset by 180°—that is facing each other—at the motor shaft 30, and a Hall sensor 32 is mounted fixed spaced in this region of the motor shaft. If a Hall element 31 then passes the sensor 32 during the rotation of the motor shaft 30, a measuring or sensor signal is generated, which is approximately digital. With (not necessarily) two Hall elements 31, two signals are thus emitted with one rotation of the motor shaft 30. By temporal evaluation of these signals, e. g. their time difference, the speed vL of the base door 7 can be determined, for example via comparative tables or a conversion into real time in the control circuit 13. By addition or subtraction of the measuring signals, a movement path or a position of the base door 7 can be determined.

A speed regulation can for example implement the speed via a PWN-controlled performance semiconductor.

For determining the zero point, the path measurement is automatically adjusted again by initializing in the zero position P0 of the base door 7 with every start, as e.g. a faulty sensor signal emission or—reception is thereby not passed on.

The drive motor 9 can be driven by actuating both movement control panels 25 or 26, even when the main switch 29 is switched off.

Instead of two separate switches per movement panel 25, 26, a single switch per movement panel is also possible, e. g. a rocker switch with neutral position, which only switches under pressure. Other forms are also possible. The type and the arrangement of the operating elements 28, 29 of the control panel 12 are not limited.

The arrangement and division of the control circuit 13 is thereby flexible and not limited, can thus also comprise several circuit boards, e. g. a display circuit board, a control circuit board and a lifting circuit board, which are spatially separated.

An extent of opening of 4 mm can be recognized by end switches 33, which deactivate a jam protection device on actuation.

The cooking appliance which is mounted in an elevated manner can also be designed without a memory unit 27, where an automatic operation is then not possible. This can be sensible for an increased operating safety, e. g. as protection against jamming.

With an activated operational state for the open state (e. g. a cooking plate, keeping hot or frying operational state), the control circuit 13 in one embodiment can prevent the open base door 7 from moving by deactivating—here: by bypassing—of the drive motor 9. In the activated operational state for the closed state, the base door 7 can be moved, so as to allow checking of food that is cooked.

FIG. 6 shows the control panel 12 from FIG. 5 in more detail. The control panel 12 comprises a left display panel 34, a centre display panel 35 and a right display panel 36, which show all possible displays in this Figure, as e.g. operational state symbols in the left display panel 34, a time, cooking duration or further parameters useful for the adjusted operational state in the centre display panel 35, and a three-digit alphanumeric display 37, a temperature unit display 38 (which can be adjusted to ° C. and ° F. here) and a step display 39 in the right display panel 36. The control panel can be switched in such a manner that only the operational states for the open state are shown in the open state of the base door, and only the operational states for the closed state in the closed state of the base door. Alternatively, relevant operational states can be displayed as active for the opening state of the base door, and non-relevant operational states as inactive, e.g. by means of different brightness, blinking, acoustic signals and/or by corresponding symbols.

Among these are a series of switches 40-51, namely
a main switch button 40 for switching the appliance on and off, possibly with a time delay,
a key button 41 for locking the appliance,
an arrow downwards button 42 for selecting individual operational states in decreasing order, this button can be switched in such a manner that only operational states for the open state can be chosen in the open state of the base door and/or that only operational states for the closed state can be chosen in the closed state of the base door;
an arrow upwards button 43 for selecting individual operational states in increasing order, this button can be switched in such a manner that only operational states for the open state can be chosen in the open state of the base door and/or that only operational states for the closed state can be chosen in the closed state of the base door;
an oven light or a light switch 44 for the active switching of an oven light (not shown) by the user,
a clock button 45 for selecting individual time functions, e. g. baking time etc,
an alarm button 46 for selecting an alarm function,
an information button 47 for accessing information, e. g. an actual temperature or a heating duration,
a minus button 48 for the negative adjustment of temperature and time functions,
a plus button 49 for the positive adjustment of temperature and time functions,
a fast heating button 50 for switching a fast heating function on and off and
an OK button or confirmation button 51 as an activation button, e. g. for time functions and operational states. In one embodiment, only an operational state which is relevant for the opening state of the base door 7 or the cooking chamber 3/the muffle 5 can be activated by actuating this button.

In this exemplary embodiment, the operational state switching mechanism thus uses two separate arrow buttons 42, 43 and possibly the confirmation button 51. The cooking appliance can be switched between different functionalities by actuation of the operational state switching mechanism. The operational states are thereby passed through in a cyclic manner. The operational state switching mechanism is not limited to the embodiment shown here.

The present invention is naturally not limited to the described embodiments, but it extends over the entire range of the claims.

### LIST OF REFERENCE CHARACTERS

1 Housing
2 Wall
3 Cooking chamber
4 Viewing window
5 Muffle
6 Muffle opening
7 Base door
8 Worktop
9 Drive motor
10 Lifting element
11 Control element
12 Control panel
13 Control circuit
14 Display elements
15 Hob
16 Hotplate heating element
17 Hotplate heating element
18 Surface heating element
19 Glass ceramic plate
20 Retaining part
21 Food carrier
22 Upper heat heating element
23 Fan
24 Seal
25 Movement control panel
25a Movement switch upwards
25b Movement switch downwards
26 Movement control panel
26a Movement switch upwards
26b Movement switch downwards
27 Memory unit
30 Motor shaft
31 Hall element
32 Sensor
33 End switch
34 Left display panel
35 Centre display panel
36 Right display panel
37 Alphanumeric display
38 Temperature unit display
39 Step display
40 Main switch
41 Key button
42 Arrow downwards button
43 Arrow upwards button
44 Oven light button
45 Clock button
46 Alarm button
47 Information button
48 Minus button
49 Plus button
50 Rapid heat button
51 OK or confirmation button
52 Control panel
53 Cooking zone switch
54 Centre display panel
55 Step display
56 Alphanumeric display
PO Zero position
P1 Intermediate position
P2 Intermediate position
PZ End position

1-9. (canceled)

10. A cooking appliance which is mounted in an elevated manner comprising:
a muffle including a cooking chamber and a base side; a muffle opening located on the base side,
a movable base door having an upper side; at least one hob on the upper side; the base door adapted to close the muffle opening;
the cooking appliance having at least one operational state for the open state of the base door and at least one operational state for the closed state of the base door; wherein only an operational state associated with the open state of the base door can be activated.

11. The cooking appliance which is mounted in an elevated manner as claimed in claim 10, wherein the operational state associated with the open state of the base door can be activated by actuating a confirmation button.

12. The cooking appliance which is mounted in an elevated manner as claimed in claim 10, wherein the operational state for the open state of the base door is a warming, hotplate, or extended cooking function.

13. The cooking appliance which is mounted in an elevated manner as claimed in claim 10, wherein the operational state for the closed state of the base door is a warming, cooking, rapid heating or pyrolysis function.

14. The cooking appliance which is mounted in an elevated manner as claimed in claim 10, wherein only an operational state associated with the opening state of the base door can be displayed.

15. The cooking appliance which is mounted in an elevated manner as claimed in claim 10 further including a control panel; the control panel indicating an operational state associated with the opening state of the base door as active; the control panel indicating an operational state which is not associated with the open state of the base door as inactive.

16. A method for operating a cooking appliance which is mounted in an elevated manner having a muffle including a cooking chamber and having a movable base door comprising:
providing an operational state for the open state of the base door so it can be activated when the base door is open, and an operational state for the closed state of the base door so it cannot be activated, and
providing an operational state for the closed state so it can be activated when the base door is closed, and an operational state for the open state so it cannot be activated.

17. The method as claimed in claim 16, further including
providing an operational state for the open state is displayed when the base door is open, and an operational state for the closed state is not displayed, and
providing an operational state for the closed state is displayed when the base door is closed, and an operational state for the open state is displayed.
